(19) United States
(12) Patent Application Publication
(10) Pub. No.: US 2009/0258228 A1
(43) Pub. Date: Oct. 15, 2009

(54) STEEL WIRE FOR SPRING

(75) Inventors: Akifumi Matsuoka, Utsunomiya-shi (JP); Yuichi Sano, Utsunomiya-shi (JP); Kenichi Okamoto, Itami-shi (JP)

Correspondence Address: OSHA LIANG L.L.P., TWO HOUSTON CENTER, 909 FANNIN, SUITE 3500, HOUSTON, TX, 77010, US

(73) Assignees: Sumitomo (SEI) Steel Wire Corp., Itami-shi, Hyogo (JP); Sumitomo Electric Tochigi Co., Ltd., Utsunomiya-shi, Tochigi (JP)

(21) Appl. No.: 11/916,787

(22) PCT Filed: Dec. 5, 2006
(86) PCT No.: PCT/JP2006/324242

§ 371 Date: Jan. 25, 2008

(30) Foreign Application Priority Data
Dec. 14, 2005 (JP) 2005-360726
Nov. 29, 2006 (JP) 2006-322280

(51) Int. Cl. F16F 1/02; B32B 15/18

(52) U.S. Cl. 428/380; 428/379

(57) ABSTRACT

Spring steel wire is formed by drawing steel wire including a phosphate film, the weight of the film being in the range of 3.0 to 5.5 g/m², and R/d being in the range of 1.06×10⁻³ to 3.92×10⁻³ where R represents surface roughness; and d represents the diameter of the spring steel wire.

### TECHNICAL FIELD

The present invention relates to spring steel wire.

### BACKGROUND ART

For example, spring steel wire including a phosphate film as disclosed in Japanese Unexamined Patent Application Publication No. 2005-171297 is a known type of spring steel wire.

### DISCLOSURE OF INVENTION

### Problem to be Solved by the Invention

In such spring steel wire including the phosphate film, failure such as a reduction in the percentage of non-defective articles produced when the spring steel wire is formed into a spring may be caused by the effect of the phosphate film.

To increase the percentage of non-defective articles produced when spring steel wire is formed into a spring, it is an object of the present invention to provide spring steel wire having satisfactory processability when being formed into a spring.

### Means for Solving the Problems

A spring steel wire of the present invention is produced by drawing steel wire including a phosphate film, the weight of the film being in the range of 3.0 to 5.5 g/m², and R/d being in the range of 1.06×10⁻³ to 3.92×10⁻³ where R represents surface roughness, and d represents the diameter of the spring steel wire.

A weight of the film of 3.0 g/m² or more can prevent a surface flaw caused by seizure due to the film having a small thickness during drawing. A weight of the film of 5.5 g/m² or less can inhibit clogging of a die caused by the film having a large thickness during drawing. Thus, the spring steel wire can be obtained without a surface flaw caused by seizure or damage.

When the spring steel wire is produced, drawing is performed in order to obtain a target diameter. To smoothly performing drawing and spring formation after drawing, a lubricant may be attached to the steel wire before drawing. In the spring steel wire in which R/d is in the range of 1.06×10⁻³ to 3.92×10⁻³ where R represents surface roughness after drawing, and d represents the diameter of the spring steel wire after drawing, the lubricant is uniformly left on the surface of the steel wire. Thus, a spring can be stably formed.

As described above, the spring steel wire having the uniformly and reliably attached lubricant can be obtained without a surface flaw caused by seizure or damage from clogging of a die. The spring steel wire has satisfactory processability during spring formation.

Preferably, the diameter is 0.45 mm or less, the surface of the spring steel wire is covered with the phosphate film and a lubricant used during drawing, and the total weight of the phosphate film and the lubricant attached to the surface is in the range of 0.04 to 0.09 g/m². Alternatively, preferably, the diameter exceeds 0.45 mm, the surface of the spring steel wire is covered with the phosphate film and a lubricant used during drawing, and the total weight of the phosphate film and the lubricant attached to the surface is in the range of 0.12 to 0.14 g/m². A total weight of 0.04 to 0.09 g/m² or 0.12 to 0.14 g/m² results in stable sliding of a jig and does not easily generate dust from the phosphate film during spring formation, thereby providing the spring steel wire having satisfactory processability.

The phosphate film formed on the steel wire is preferably formed by electrolytic treatment. In this case, the steel wire having a uniform phosphate film can be produced. Thus, the spring steel wire having satisfactory processability can be reliably produced.

The steel wire is preferably high-carbon steel wire. In this case, the spring steel wire having excellent strength can be produced.

### ADVANTAGES

According to the present invention, spring steel wire having satisfactory processability when being formed into a spring can be provided. Thus, the use of the spring steel wire of the present invention can increase the percentage of non-defective springs.

### BRIEF DESCRIPTION OF THE DRAWINGS

FIG. 1 is a schematic view of a coil spring formed of spring steel wire according to an embodiment.

FIG. 2 shows a procedure for fabricating spring steel wire according to an embodiment.

FIG. 3 shows a schematic block diagram of an apparatus for producing a coil spring.

FIG. 4 illustrates the ten-point height of irregularities.

### REFERENCE NUMERALS

W1 spring steel wire
S1 coil spring

### BEST MODE FOR CARRYING OUT THE INVENTION

Preferred embodiments of the present invention will be described in detail below with reference to the drawings. The same or equivalent elements are designated using the same reference numerals, and redundant description is not repeated.

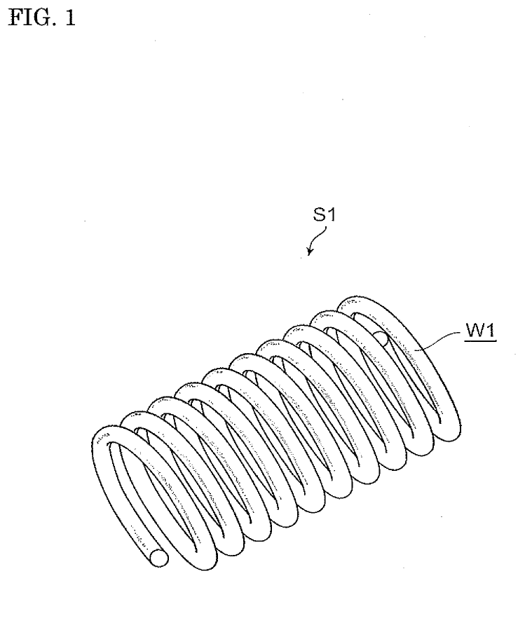

FIG. 1 is a schematic view of a coil spring formed of spring steel wire according to this embodiment. The coil spring S1 shown in FIG. 1 is formed by winding the spring steel wire W1. The spring steel wire W1 is formed by drawing steel wire including a phosphate film. The steel wire is high-carbon steel wire. The use of the high-carbon steel wire results in the spring steel wire having excellent strength.

A method for producing the spring steel wire W1 will be described below.

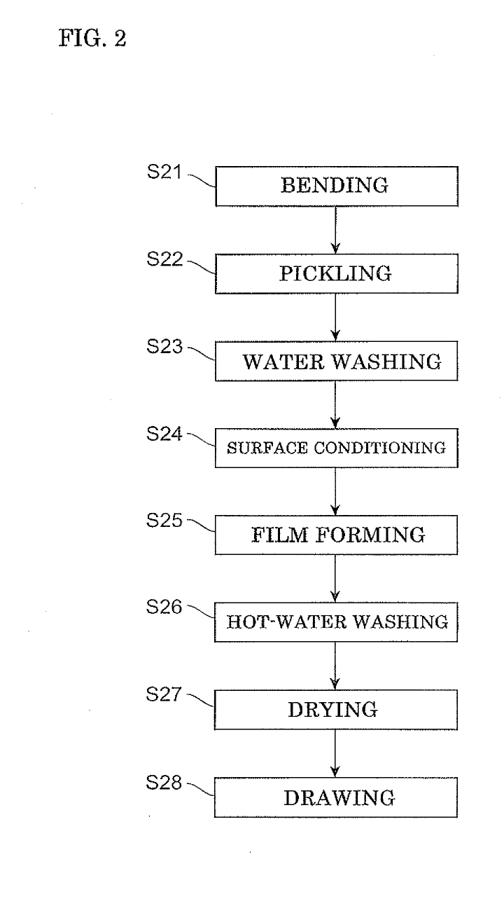

FIG. 2 shows a method for producing the spring steel wire W1. As shown in FIG. 2, the spring steel wire W1 is produced as follows: Steel wire from a supply reel is subjected to bending with a mechanical descaler or the like (step S21). After bending, the steel wire is pickled to remove oxides attached on the surface of the steel wire (step S22). Pickling may be performed by electrolytic pickling or non-electrolytic pickling (batch process). In this embodiment, electrolytic pickling in which the steel wire is used as a cathode is employed. The reason will be described in detail below.

After pickling, the steel wire is subjected to water washing to wash away an acid solution adhering to the surface (step S23). After water washing, the steel wire is subjected to surface conditioning (step S24). Surface conditioning is performed so as to rapidly form a dense phosphate film.

A phosphate film is formed on the steel wire subjected to surface conditioning (step S25). The phosphate film may be formed by an electrolytic process or a non-electrolytic process (batch process). In this embodiment, an electrolytic process using the steel wire as a cathode is employed. The weight of the phosphate film is set in the range of 3.0 to 5.5 g/m². A weight of the film of less than 3.0 g/m² is liable to cause a surface flaw caused by seizure during drawing. A weight of the film exceeding 5.5 g/m² causes clogging of a die during drawing, thus not easily producing steel wire having a uniform surface. Consequently, a weight of the phosphate film of 3.0 to 5.5 g/m² results in the spring steel wire without a surface flaw caused by seizure or damage.

Subsequently, the resulting steel wire including the phosphate film is subjected to hot-water washing (step S26). Hot-water washing is performed in order to wash away an acid solution and to facilitate the formation of the phosphate film. After hot-water washing, the steel wire is dried (step S27). The dry steel wire is subjected to the application of a lubricant and drawing with a die (step S28). Thereby, the spring steel wire W1 is produced. The resulting spring steel wire W1 is wound onto a take-up reel.

In the above-described production method, adjustment is performed in such a manner that R/d is in the range of 1.06×10⁻³ to 3.92×10⁻³ where R represents surface roughness, and d represents the diameter of the spring steel wire W1. Adjusting R/d within the range results in the spring steel wire W1 having the lubricant uniformly left on the surface thereof. When R/d is less than 1.06×10⁻³, most of the lubricant is attached to the die during drawing because of the excessively flat surface, thus possibly resulting in the spring steel wire W1 scarcely having the lubricant. When R/d exceeds 3.92×10.3, the spring steel wire W1 may have nonuniform dispersion of the lubricant because of an excessively rough surface. The use of the spring steel wire W1 in which R/d is in the range of 1.06×10⁻³ to 3.92×10⁻³ can smoothly form the coil spring S1 because of the lubricant uniformly attached on the surface. R/d is preferably in the range of 1.06×10⁻³ to 2.27×10⁻³ because the lubricant is more uniformly attached on the surface.

In the production method, at a wire diameter of 0.45 mm or less (e.g., 0.26 to 0.45 mm), the total weight of the phosphate film and the lubricant attached to the spring steel wire W1 is adjusted to 0.04 to 0.09 g/m². A total weight of less than 0.04 g/m² may impair sliding properties of the jig during the formation of the coil spring S1. A total weight exceeding 0.09 g/m² may result in the excessively slidable jig and the generation of dust during the formation of the coil spring S1. In the case where the wire diameter is 0.45 mm or less, when the total weight of the phosphate film and the lubricant attached is adjusted to 0.04 to 0.09 g/m², the spring steel wire W1 providing stable sliding of the jig and not easily generating dust from the phosphate film during spring formation can be obtained.

Similarly, at a wire diameter exceeding 0.45 mm (e.g., 0.50 to 1.80 mm), the total weight of the phosphate film and the lubricant attached to the spring steel wire W1 is preferably adjusted to 0.12 to 0.14 g/m². A total weight of less than 0.12 g/m² may impair sliding properties of the jig during the formation of the coil spring S1. A total weight exceeding 0.14 g/m² may result in the excessively slidable jig and the generation of dust during the formation of the coil spring S1. In the case where the wire diameter exceeds 0.45 mm, when the total weight of the phosphate film and the lubricant attached is adjusted to 0.12 to 0.14 g/m², the spring steel wire W1 providing stable sliding of the jig and not easily generating dust from the phosphate film during spring formation can be obtained.

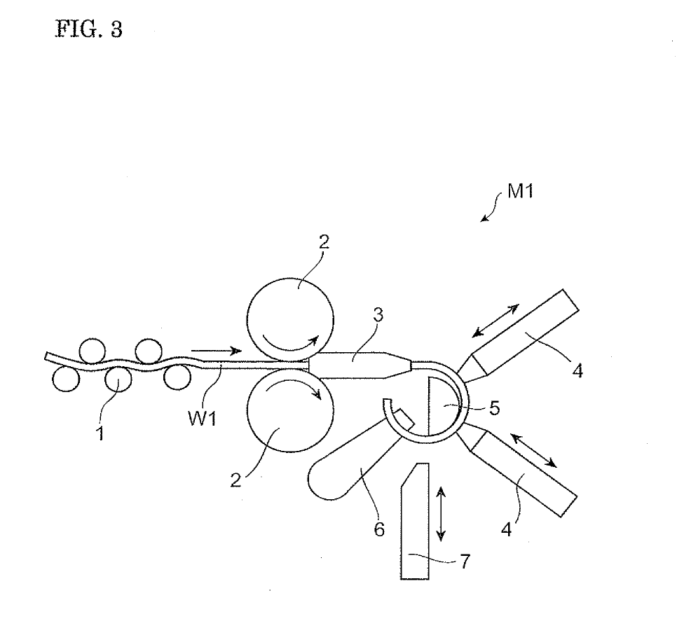

A method for forming the coil spring S1 will be described below. FIG. 3 shows a schematic block diagram of an apparatus for producing a coil spring. According to the production apparatus M1, the spring steel wire W1 unreeled from the take-up reel is corrected to have a substantially linear form with a roller 1. The corrected spring steel wire W1 is guided to a wire guide 3 in response to the rotation of feed rollers 2 and bent and wound around a mandrel 5 with coiling pins 4. The pitch of the coil is set at a predetermined value with a pitch tool 6 during winding. When a predetermined number of turns is achieved, the spring steel wire W1 is cut with a cutter 7 to form the coil spring S1.

The reason why the electrolytic process is applied to pickling and the formation of the phosphate film will be described below. To compare the electrolytic process with the non-electrolytic process, the following experiments were conducted: Pickling and phosphate-film formation were performed by the electrolytic process and the non-electrolytic process. Nonuniformity in weight of the phosphate film was examined. The term “non-electrolytic process” defined here refers to a process in which a steel wire is immersed in a solution to perform pickling and the formation of the phosphate film.

A solution containing 20 to 70 g/L of PO₄ ions, 20 to 50 g/L of Zn ions, and 30 to 80 g/L of NO₃ ions was used for the formation of the phosphate films. Thus, the phosphate films to be formed are zinc phosphate films. The temperature was set at 75° C. to 85° C. during the formation of the phosphate films. Steel wires having diameters of 1.05 mm and 5.00 mm were prepared. A target weight of each of the phosphate films attached was set at 5.5 g/m². Electric current densities were set at 13.2 A/dm² for the steel wire having a diameter of 1.05 mm and 11.8 A/dm² for the steel wire having a diameter of 5.00 mm. A treating tank for use in the formation of the phosphate films had a length of 25,000 mm. After the formation of the phosphate films, hot-water washing and drying were performed. The film weights were measured at five points spaced at 10-mm intervals of each steel wire. Table I shows the results of the employment of the electrolytic process. Table II shows the results of the employment of the non-electrolytic process.

TABLE I

| | | Diameter (mm) | Film weight (g/m²) |
|---|---|---|---|
| Example 1 | Point 1 | 1.05 | 5.54 |
| | Point 2 | 1.05 | 5.69 |
| | Point 3 | 1.05 | 5.32 |
| | Point 4 | 1.05 | 5.22 |
| | Point 5 | 1.05 | 5.84 |
| | Mean ± standard | — | 5.502 ± 0.256 |
| | deviation | | |
| Example 2 | Point 6 | 5.00 | 5.36 |
| | Point 7 | 5.00 | 5.74 |
| | Point 8 | 5.00 | 5.23 |
| | Point 9 | 5.00 | 5.22 |
| | Point 10 | 5.00 | 5.65 |
| | Mean ± standard | — | 5.440 ± 0.241 |
| | deviation | | |

TABLE II

| | | Diameter (mm) | Film weight (g/m²) |
|---|---|---|---|
| Comparative | Point 11 | 1.05 | 4.95 |
| Example 1 | Point 12 | 1.05 | 5.87 |
| | Point 13 | 1.05 | 5.21 |
| | Point 14 | 1.05 | 6.13 |
| | Point 15 | 1.05 | 5.90 |
| | Mean ± standard | — | 5.61 ± 0.504 |
| | deviation | | |
| Comparative | Point 16 | 5.00 | 5.50 |
| Example 2 | Point 17 | 5.00 | 5.04 |
| | Point 18 | 5.00 | 5.87 |
| | Point 19 | 5.00 | 4.52 |
| | Point 20 | 5.00 | 5.65 |
| | Mean ± standard | — | 5.316 ± 0.539 |
| | deviation | | |

In Example 1, the mean of values at Points 1 to 5 is 5.502 g/m², and the standard deviation is 0.256. In Comparative Example 1, the mean of values at Points 11 to 15 of the phosphate film is about 5.61 g/m², and the standard deviation is 0.504. Therefore, in the case of the steel wire having a diameter of 1.05 mm, the results demonstrated that the standard deviation when the electrolytic process was employed was reduced by about 51% compared with the case where the non-electrolytic process was employed.

In Example 2, the mean of values at Points 6 to 10 is 5.440 g/m², and the standard deviation is 0.241. In Comparative Example 2, the mean of values at Points 16 to 20 of the phosphate film is 5.316 g/m², and the standard deviation is 0.539. Therefore, in the case of the steel wire having a diameter of 5.00 mm, the results demonstrated that the standard deviation when the electrolytic process was employed was reduced by about 55% compared with the case where the non-electrolytic process was employed.

As described above, the results demonstrated that the employment of the electrolytic process reduced nonuniformity in weight of the film and formed the uniform phosphate film compared with the case of the employment of the non-electrolytic process. Therefore, the electrolytic process is preferably employed for pickling and the formation of the phosphate film.

The following experiments were conducted to examine processability during spring formation: A plurality of steel wires subjected to pickling and phosphate-film formation by the electrolytic process and a plurality of steel wires subjected to pickling and phosphate-film formation by the non-electrolytic process were prepared and drawn to form spring steel wires. The resulting spring steel wires were formed into coil springs. The percentage of non-defective coil springs was calculated in each process.

Specifically, a plurality of steel wires subjected to pickling and phosphate-film formation by the electrolytic process, different in phosphate film weights, and each having a diameter of 1.05 mm, were prepared as Examples 3 to 6. Furthermore, a plurality of steel wires subjected to pickling and phosphate-film formation by the non-electrolytic process, different in phosphate film weights, and each having a diameter of 1.05 mm, were prepared as Comparative Examples 3 to 5. The steel wires were drawn with a 7- to 13-step die to form spring steel wires each having a diameter of 0.26 mm. A lubricant containing an about 70% sodium- or calcium-based metallic soap was used during drawing.

A plurality of steel wires subjected to pickling and phosphate-film formation by the electrolytic process, different in phosphate film weights, and each having a diameter of 1.7 mm, were prepared as Examples 7 and 8. A steel wire subjected to pickling and phosphate-film formation by the non-electrolytic process and having a diameter of 1.7 mm was prepared as Comparative Example 6. The steel wires were drawn with a 7- to 13-step die to form spring steel wires each having a diameter of 0.45 mm. A lubricant containing an about 70% sodium- or calcium-based metallic soap was used during drawing.

A steel wire subjected to pickling and phosphate-film formation by the electrolytic process and having a diameter of 2.3 mm was prepared as Example 9. A steel wire subjected to pickling and phosphate-film formation by the non-electrolytic process and having a diameter of 2.3 mm was prepared as Comparative Example 7. The steel wires were drawn with a 7- to 13-step die to form spring steel wires each having a diameter of 0.5 mm. A lubricant containing an about 70% sodium- or calcium-based metallic soap was used during drawing.

A steel wire subjected to pickling and phosphate-film formation by the electrolytic process and having a diameter of 4.00 mm was prepared as Example 10. A steel wire subjected to pickling and phosphate-film formation by the non-electrolytic process and having a diameter of 4.00 mm was prepared as Comparative Example 8. The steel wires were drawn with a 7- to 13-step die to form spring steel wires each having a diameter of 1.2 mm. A lubricant containing an about 70% sodium- or calcium-based metallic soap was used during drawing.

A plurality of steel wires subjected to pickling and phosphate-film formation by the electrolytic process, different in phosphate film weights, and each having a diameter of 5.00 mm, were prepared as Examples 11 to 14. Furthermore, a plurality of steel wires subjected to pickling and phosphate-film formation by the non-electrolytic process, different in phosphate film weights, and each having a diameter of 5.00 mm, were prepared as Comparative Examples 9 to 11. The steel wires were drawn with a 7- to 13-step die to form spring steel wires each having a diameter of 1.8 mm. A lubricant containing an about 70% sodium- or calcium-based metallic soap was used during drawing.

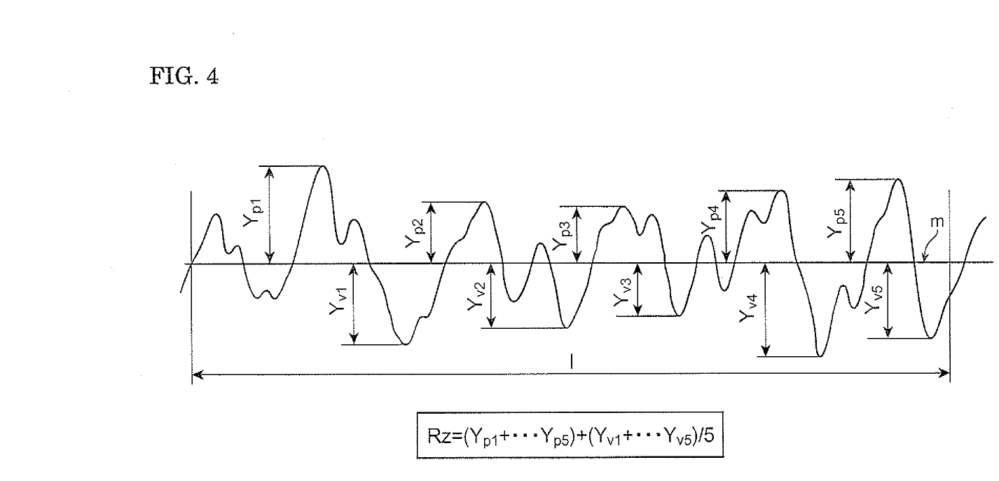

The total weight of the phosphate film and the lubricant attached to each of the resulting spring steel wires was measured. In addition, surface roughness was also measured. The term “surface roughness” refers to the ten-point height of irregularities (Rz) defined or indicated by JISB0601-2001. That is, as shown in FIG. 4, the ten-point height of irregularities refers to in an evaluation length of a profile curve, the difference between the mean value of the five highest peaks in the direction of longitudinal magnification and the mean value of the five deepest valleys from a line parallel to a mean line and not crossing the profile curve, in terms of micrometer (μm).

After measurement of the total weight and surface roughness, each spring steel wire was formed into coil springs. The percentage of non-defective coil springs formed was calculated. The phrase “percentage of non-defective coil springs” defined here means the percentage obtained by dividing the number of non-defective coil springs each having a free length within a specification by the total number of coil springs formed. The free length of each coil spring was set at 40 mm, 60 mm, 70 mm, 100 mm, or 200 mm.

Tables 3 to 7 show the measurement results. Table 3 shows the results at a wire diameter of 0.26 mm. Table 4 shows the results at a wire diameter of 0.45 mm. Table 5 shows the results at a wire diameter of 0.5 mm. Table 6 shows the results at a wire diameter of 1.2 mm. Table 7 shows the results at a wire diameter of 1.8 mm. In Tables, R represents surface roughness, d represents a wire diameter, and D represents the mean diameter of each coil. Thus, D/d represents a spring index.

TABLE III

| | | | | | Total | | | |
|---|---|---|---|---|---|---|---|---|
| | | Film weight | Surface | | weight | | Free | Percentage of |
| | | before drawing | roughness | R/d | attached | | length | non-defective |
| | Process | (g/m²) | (μm) | (×10⁻³) | (g/m²) | D/d | (mm) | article (%) |
| Example 3 | Electrolytic | 3.0 | 0.40 | 1.54 | 0.042 | 4.8 | 40 | 93.5 |
| Example 4 | Electrolytic | 4.0 | 0.59 | 2.27 | 0.078 | 4.8 | 40 | 93.5 |
| Example 5 | Electrolytic | 5.5 | 1.02 | 3.92 | 0.087 | 4.8 | 40 | 85.0 |
| Example 6 | Electrolytic | 3.5 | 0.80 | 3.08 | 0.065 | 4.8 | 200 | 81.6 |
| Comparative | Non- | 3.5 | 1.15 | 4.42 | 0.103 | 4.8 | 40 | 68.0 |
| Example 3 | electrolytic | | | | | | | |
| Comparative | Non- | 4.0 | 1.48 | 5.69 | 0.115 | 4.8 | 40 | 74.8 |
| Example 4 | electrolytic | | | | | | | |
| Comparative | Non- | 5.5 | 1.29 | 4.96 | 0.132 | 4.8 | 40 | 79.1 |
| Example 5 | electrolytic | | | | | | | |

TABLE IV

| | | | | | Total | | | |
|---|---|---|---|---|---|---|---|---|
| | | Film weight | Surface | | weight | | Free | Percentage of |
| | | before drawing | roughness | R/d | attached | | length | non-defective |
| | Process | (g/m²) | (μm) | (×10⁻³) | (g/m²) | D/d | (mm) | article (%) |
| Example 7 | Electrolytic | 3.5 | 0.70 | 1.56 | 0.082 | 9.5 | 60 | 90.7 |
| Example 8 | Electrolytic | 5.5 | 1.25 | 2.78 | 0.090 | 9.5 | 60 | 88.4 |
| Comparative | Non- | 5.5 | 1.85 | 4.11 | 0.214 | 9.5 | 60 | 83.2 |
| Example 6 | electrolytic | | | | | | | |

TABLE V

| | | | | | Total | | | |
|---|---|---|---|---|---|---|---|---|
| | | Film weight | Surface | | weight | | Free | Percentage of |
| | | before drawing | roughness | R/d | attached | | length | non-defective |
| | Process | (g/m²) | (μm) | (×10⁻³) | (g/m²) | D/d | (mm) | article (%) |
| Example 9 | Electrolytic | 5.5 | 1.78 | 3.56 | 0.124 | 9.5 | 70 | 90.1 |
| Comparative | Non- | 5.5 | 2.02 | 4.04 | 0.221 | 9.5 | 70 | 85.5 |
| Example 7 | electrolytic | | | | | | | |

TABLE VI

| | | | | | Total | | | |
|---|---|---|---|---|---|---|---|---|
| | | Film weight | Surface | | weight | | Free | Percentage of |
| | | before drawing | roughness | R/d | attached | | length | non-defective |
| | Process | (g/m²) | (μm) | (×10⁻³) | (g/m²) | D/d | (mm) | article (%) |
| Example 10 | Electrolytic | 5.5 | 4.2 | 3.50 | 0.129 | 12.9 | 70 | 92.5 |
| Comparative | Non- | 5.5 | 5.9 | 4.92 | 0.324 | 12.9 | 70 | 89.5 |
| Example 8 | electrolytic | | | | | | | |

TABLE VII

| | | | | | Total | | | |
|---|---|---|---|---|---|---|---|---|
| | | Film weight | Surface | | weight | | Free | Percentage of |
| | | before drawing | roughness | R/d | attached | | length | non-defective |
| | Process | (g/m²) | (μm) | (×10⁻³) | (g/m²) | D/d | (mm) | article (%) |
| Example 11 | Electrolytic | 4.5 | 2.01 | 1.12 | 0.123 | 12.5 | 60 | 97.7 |
| Example 12 | Electrolytic | 5.5 | 1.96 | 1.09 | 0.138 | 12.5 | 60 | 96.2 |
| Example 13 | Electrolytic | 5.5 | 2.07 | 1.15 | 0.121 | 15.7 | 60 | 95.8 |
| Example 14 | Electrolytic | 5.5 | 1.91 | 1.06 | 0.132 | 15.7 | 100 | 94.7 |
| Comparative | Non- | 4.0 | 7.10 | 3.94 | 0.285 | 12.5 | 60 | 90.3 |
| Example 9 | electrolytic | | | | | | | |
| Comparative | Non- | 5.5 | 7.40 | 4.11 | 0.354 | 15.7 | 60 | 92.7 |
| Example 10 | electrolytic | | | | | | | |
| Comparative | Non- | 5.5 | 7.30 | 4.06 | 0.309 | 15.7 | 100 | 91.4 |
| Example 11 | electrolytic | | | | | | | |

A spring steel wire in each of Examples 3 to 14 was the same as the spring steel wire W1 according to this embodiment and produced under the above-described conditions. That is, pickling and phosphate-film formation were performed by the electrolytic process, and the weight of each phosphate film was in the range of 3.0 to 5.5 g/m².

A spring steel wire in each of Comparative Examples 3 to 11 was different from the spring steel wire W1 according to this embodiment in the employment of the non-electrolytic process for pickling and phosphate-film formation.

The measurement results demonstrated that in the spring steel wire in each of Examples 3 to 6, R/d was in the range of 1.06×10⁻³ to 3.92×10⁻³ and that the total weight of the phosphate film and the lubricant attached was in the range of 0.04 to 0.09 g/m². The percentage of non-defective coil springs formed of the spring steel wire in each of Examples 3 to 6 was 81.6% to 93.5%.

In the spring steel wire in each of Comparative Examples 3 to 5, R/d was in the range of 4.42×10⁻³ to 5.69×10⁻³ and that the total weight of the phosphate film and the lubricant attached was in the range of 0.103 to 0.132 g/m². The percentage of non-defective coil springs formed of the spring steel wire in each of Comparative Examples 3 to 5 was in the range of 68.0% to 79.1%.

In the spring steel wire in each of Examples 3 to 6, the percentage of non-defective coil springs was high compared with the spring steel wire in each of Comparative Examples 3 to 5. Thus, the results demonstrated that in the case where pickling and phosphate-film formation were performed by the electrolytic process and where the weight of the phosphate film was in the range of 3.0 to 5.5 g/m², the spring steel wire having satisfactory processability during spring formation was obtained.

A cause for the percentage of non-defective coil springs in each of Comparative Examples 3 to 5 lower than that in each of Examples 3 to 6 will be discussed below.

The reason why the use of the spring steel wire in each of Comparative Examples 3 to 5 results in a low percentage of non-defective coil springs may be as follows: As is apparent from the above-described experiments, the employment of the non-electrolytic process increases nonuniformity in film weight compared with the electrolytic process. A large nonuniformity in film weight increases surface roughness. Spring steel wire formed by drawing steel wire having a rough surface also has a rough surface. Such spring steel wire having a rough surface has nonuniform distribution of a lubricant, thus resulting in difficulty in stably forming a spring and reducing the percentage of non-defective coil springs. In fact, in Comparative Examples 3 to 5 in which the non-electrolytic process is employed, surface roughness is large, and the percentage of non-defective coil springs is low, compared with Examples 3 to 6 in which the electrolytic process is employed.

The spring steel wire having a rough surface has large irregularities on the surface. Thus, the lubricant attached in surface depressions is not removed during drawing and is left. Therefore, a large amount of the lubricant is attached to the spring steel wire having a rough surface. A large amount of the lubricant attached results in the excessively slidable jig during spring formation, thereby resulting in difficulty in stably forming a spring and reducing the percentage of non-defective coil springs. In fact, in Comparative Examples 3 to 5 in which the non-electrolytic process is employed, the total weight including the lubricant is large, and the percentage of non-defective coil springs is low, compared with Examples 3 to 6 in which the electrolytic process is employed.

In consideration of the above-described results, to increase the percentage of non-defective coil springs, pickling and phosphate-film formation need not necessarily to be performed by the electrolytic process. That is, a proper R/d may be obtained. Specifically, spring steel wire may be obtained in such a manner that R/d is in the range of 1.06×10⁻³ to 3.92×10⁻³. Furthermore, the percentage of non-defective coil springs can be reliably increased as long as the total weight of the phosphate film and the lubricant attached is the same as in Examples 3 to 14, i.e., the total weight is in the range of 0.04 to 0.09 g/m² or 0.12 to 0.14 g/m².

As described above, in this embodiment, drawing the steel wire having a weight of the phosphate film of 3.0 to 5.5 g/m² results in the spring steel wire W1 without a surface flaw caused by seizure and the like. Setting R/d to 1.06×10⁻³ to 3.92×10⁻³ results in the spring steel wire W1 having the lubricant uniformly and reliably attached. Therefore, the spring steel wire having satisfactory processability during spring formation can be obtained.

The preferred embodiment of the present invention has been described. However, the present invention is not limited to these embodiments. For example, in this embodiment, the spring steel wire is formed into the coil springs. However, springs that can be formed of the spring steel wire according to the present invention are not limited to the coil springs.

1. A spring steel wire produced by drawing steel wire including a phosphate film, wherein the weight of the film is in the range of 3.0 to 5.5 g/m², and R/d is in the range of 1.06×10³ to 3.92×10 where R represents surface roughness; and d represents the diameter of the spring steel wire.

2. The spring steel wire according to claim 1, wherein the diameter is 0.45 mm or less, and
wherein the surface of the spring steel wire is covered with the phosphate film and a lubricant used during drawing, and the total weight of the phosphate film and the lubricant attached to the surface is in the range of 0.04 to 0.09 g/m².

3. The spring steel wire according to claim 1, wherein the diameter exceeds 0.45 mm, and
wherein the surface of the spring steel wire is covered with the phosphate film and a lubricant used during drawing, and the total weight of the phosphate film and the lubricant attached to the surface is in the range of 0.12 to 0.14 g/m².

4. The spring steel wire according to claim 1, wherein the phosphate film is formed by electrolytic treatment.

5. The spring steel wire according to claim 1, wherein the steel wire is high-carbon steel wire.

6. The spring steel wire according to claim 2, wherein the phosphate film is formed by electrolytic treatment.

7. The spring steel wire according to claim 3, wherein the phosphate film is formed by electrolytic treatment.

8. The spring steel wire according to claim 6, wherein the steel wire is high-carbon steel wire.

9. The spring steel wire according to claim 7, wherein the steel wire is high-carbon steel wire.

10. The spring steel wire according to claim 2, wherein the steel wire is high-carbon steel wire.

11. The spring steel wire according to claim 3, wherein the steel wire is high-carbon steel wire.

12. The spring steel wire according to claim 4, wherein the steel wire is high-carbon steel wire.
